(19) United States
(12) Patent Application Publication
(10) Pub. No.: US 2002/0153672 A1
(43) Pub. Date: Oct. 24, 2002

(54) Elastic metal gasket

(76) Inventors: Philippe Caplain, Saint Paul Trois Chateaux (FR); Christian Rouaud, Bourg Saint Andeol (FR)

Correspondence Address: Robert E. Krebs, THELEN REID & PRIEST LLP, P.O. Box 640640, SAN JOSE,, CA, 95164-0640, US

(21) Appl. No.: 09/989,532

(22) Filed: Nov. 21, 2001

(30) Foreign Application Priority Data
Apr. 23, 2001 (FR) 01 05427

(51) Int. Cl. F16L 17/06

(52) U.S. Cl. 277/608

(57) ABSTRACT

The gasket makes it possible to maintain a high level of tightness, in spite of the low forces involved, through the use of a sheet of ductile material as outer envelope.

Essentially, it includes a metal core (1) that is relatively elastic, enclosed by an outer envelope (2) made of ductile material, for instance a coat of aluminium. These two elements do not have any mechanical bond between them, so that possible movements and the distribution of forces are possible when the gasket is squeezed and in operation.

### FIELD OF THE INVENTION

The invention concerns static sealing, and in particular elastic metal gaskets to ensure tightness with clamping forces less than those needed for the efficiency of spring core gaskets.

### PREVIOUS TECHNIQUE AND PROBLEM POSED

Considering the choice of materials with respect to their insensitivity to corrosive fluids, and their performance at high and low temperatures and their durability in the course of time, metal gaskets are used in a wide variety of application areas, among which may be mentioned, although this is not considered limitative in any way, the chemical, petroleum and nuclear industries, as well as the automobile and space sectors. The quality of sealing offered by a gasket depends in particular on the specific pressure developed between the contact surfaces of the gasket and the assembly flanges between which the gasket is placed. During the initial tightening of the assembly, the specific contact pressure must be sufficient to allow the gasket to match the uneven surfaces of the flanges. Therefore, it is clear that the specific contact pressure must be relatively high and, in any case, greater than the pressure of the fluids prevailing inside the volume contained by the gasket and the gasket clamping surfaces.

Furthermore, in many applications, the tightening force has to remain low. This is particularly so when the assembly is difficult to reach, making it awkward to handle the attaching tools, as is the case in the nuclear industry and the semiconductor industry, and when the assemblies using materials with demanding properties have to be light and will not support high forces, as is the case in the aeronautical and space industries. There are two known metal gasket structures of this type, characterized by the use of an open or closed metal central core on which the electronic depositing of a ductile material is performed. For this type of gasket, tightness is obtained by the plastic deformation of the material forming the outer ductile coat. Accordingly, it is necessary to develop contact pressure by means of a metal core, exceeding the elastic limit of the coating to be deformed.

There is one industrial area in which it is no longer possible to use this type of metal gasket. It concerns the area of vacuum or intense vacuum in which lightweight structures practically demand the use of aluminium as sealing coating. But there is no way of depositing an aluminium coating on a metal substrate without creating porosity, or that is compatible with the surface states and surface hardness required by very high sealing levels.

The purpose of the invention is therefore to remedy this drawback by offering a gasket of a different type to those described in the above paragraphs, using ductile material like aluminium, copper, silver or gold, or other materials that can be deposited according to the customary processes.

### SUMMARY OF THE INVENTION

For this purpose, the main goal of the invention is a elastic metal gasket, open or closed, comprising an elastic metal core and an outer envelope of ductile material, in which the metal core is inserted. When at rest, the gasket will have a circular section.

According to the invention, the outer envelope and the metal core have no mechanical link with one another so that they can be moved and deformed independently of each other.

In an initial execution of the gasket according to the invention, the outer envelope can consist of a single metal sheet.

In another execution of this gasket, this outer envelope can be obtained by two sheets of metal.

In other cases, the metal core can also be made of one or several metal sheets.

In another alternative of the gasket according to the invention, the metal core and the outer envelope will both be opened at the same point.

Similarly, another alternative consists in providing for a metal core and an outer envelope that are both closed.

Lastly, in a final execution, there could be the possibility of using a closed metal core on which an outer external envelope is placed.

Preferably, the material forming the outer layer will be aluminium.

In many executions of the gasket according to the invention, it is generally of annular shape. In this case, the opening can be placed toward the axis of symmetry of the gasket, or opposite it.

The gasket may also be of different shapes, for instance it may be elliptical, triangular or rectangular.

### LIST OF ILLUSTRATIONS

The invention and its various properties will be better understood with reference to the following description which is illustrated by the figures representing respectively:

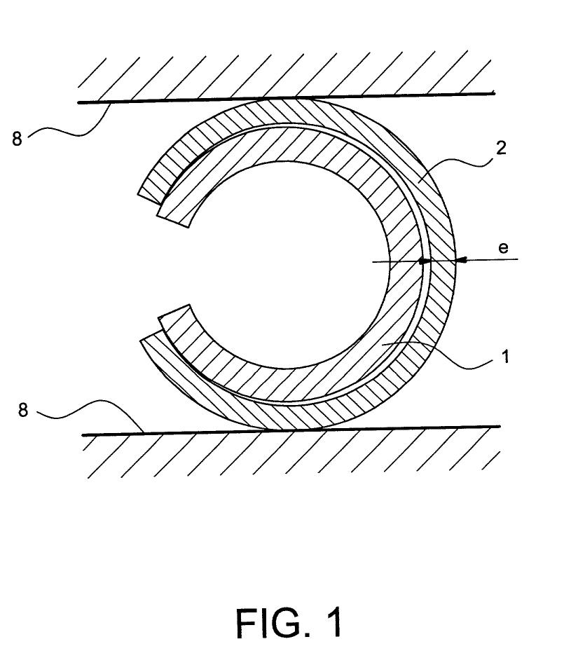

FIG. 1, a sectional view showing the section of a gasket according to an initial execution of the invention;

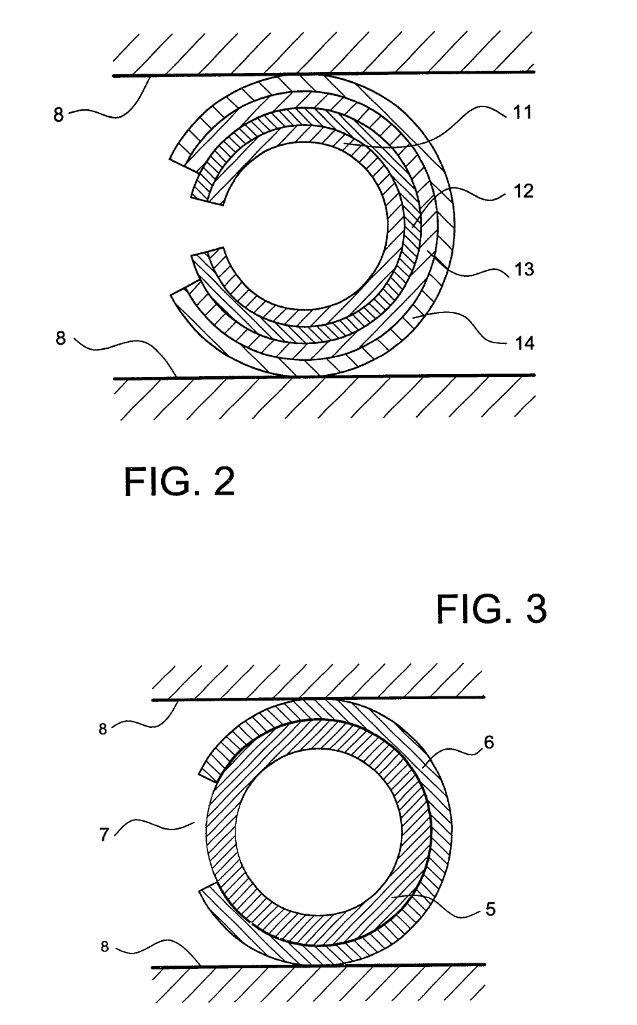

FIG. 2, a sectional view of a gasket according to a second execution of the invention;

FIG. 3, a sectional view of a third execution of the gasket according to the invention; and

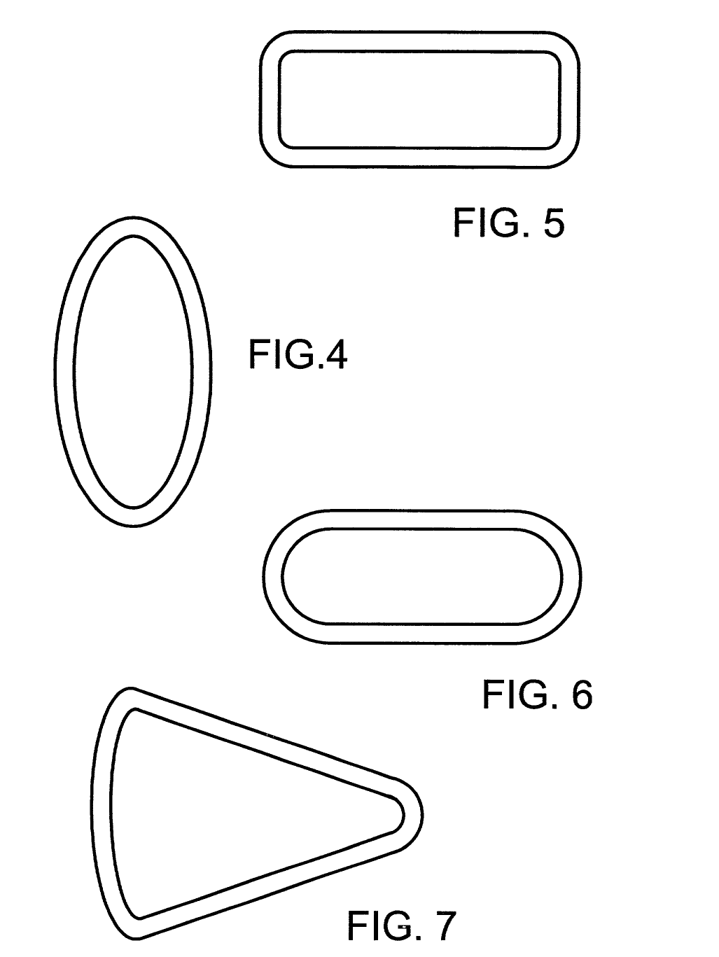

FIGS. 4 to 7, various shapes that can be given to the gasket.

### DETAILED DESCRIPTION OF THREE EXECUTIONS OF THE INVENTION

FIG. 1 shows the gasket according to the invention with a circular section but that is open; this opening can be on one side or the other, toward the centre of the gasket or opposite it, when the gasket is annular. The gasket is shown in contact between the two sealing flanges 8.

Therefore, essentially, the gasket includes a metal core 1, placed centrally and which is inserted into an outer envelope 2. Therefore, metal core 1 must be deformable but particularly strong to oppose sufficient reaction force to obtain tightness by the partial crushing of outer envelope 2. The materials used to form the metal core 1 can be, for instance, hardened stainless steel, copper-Beryllium, nickel or titanium alloys.

To obtain outer envelope 2 which has to be ductile, it is possible to choose materials such as tin, silver, gold, copper or materials that have been rendered ductile, like annealed stainless steel or annealed nickel, but in particular, aluminium.

According to the invention, it is essential that metal core 1 is purely and simply force-fitted into outer envelope 2 and that there is no mechanical linkage between these two parts. Indeed, a break between these two main parts would make it possible to benefit simultaneously from the mechanical properties of materials that have complementary characteristics, and thus overcome interaction faults between these two parts.

To do this, in FIG. 1, we have shown an interstice a located between outer envelope 2 and the metal core 1 to materialize any movements or dilatation of these two elements with respect to one another.

In addition, the use of a metal core, in the form of an open or closed tube, will allow the stiffness of the gasket to be modified in an almost unlimited manner. This is not the case if a metal spring with tight turns is used and which could lie upon or be inserted into the outer envelope. One concrete execution was obtained with a gasket having an outside diameter of approximately 5 mm. It consists of an outer envelope of aluminium approximately 0.5 mm thick and a metal core of nickel alloy 0.61 mm thick and 4 mm in diameter. This geometrical association results in crushing of 0.8 mm for a linear force of approximately 150 N.mm-1 and a tightness level of 10-10 mbar.1.s-1 in helium.

With reference to FIG. 2, it is possible to produce the two main parts of a gasket of two leaves of equal thickness. In other words, a metal core of this type of gasket is obtained by two leaves 11 and 12, equal in thickness, rolled within one another. Similarly, the outer envelope consists of two ductile envelopes 13 and 14 shaped around the metal core 12.

A “multileaf” structure like this offers better resistance to fatigue, for instance, during cyclic mechanical solicitations.

Finally, FIG. 3 shows a third execution of a gasket according to the invention in which metal core 5 has a closed section whereas the outer envelope 6 placed around it has a side opening 7. A configuration like this makes it possible to improve stiffness compared to the designs of FIGS. 1 and 2 by a factor of three to four.

This new possibility makes it possible to obtain metal cores that are better suited to the envelopes, that are less ductile, made of material such as copper, nickel or stainless steel.

Note that in many versions of the gasket according to the invention, it is generally annular in shape. However, in other versions of the gasket according to the invention, it may be elliptical (FIG. 4), rectangular, generally rectangular with rounded corners (FIG. 5), triangular, oblong (FIG. 6) or take any of the other shapes resulting from a combination and/or a modification of these shapes (FIG. 7).

1. An elastic metal gasket with an elastic metal core (1, 5, 11 and 12) and an outer envelope (2, 6, 13 and 14) of ductile material, into which is inserted the metal core, while the gasket, when at rest, has a circular section, characterized by the fact that the outer envelope (2, 6, 13 and 14) and the metal core (1, 5, 11 and 12) do not have any mechanical links with one another so as to be able to move and be deformed independently of each other.

2. A gasket according to claim 1, characterized by the fact that the outer envelope (2, 6) consists of a single metal sheet.

3. A gasket according to claim 1, characterized by the fact that the outer envelope consists of two sheets (13, 14).

4. A gasket according to claim 3, characterized by the fact that the metal core consists of two sheets (11, 12).

5. A gasket according to claim 1, characterized by the fact that metal cores (1, 11 and 12) and outer envelopes (2, 13 and 14) are open.

6. A gasket according to claim 1, characterized by the fact that the metal core (5) is closed and outer envelope (6) is open.

7. A gasket according to claim 1, characterized by the fact that the material forming the outer envelope is aluminium.

8. A gasket according to claim 1, characterized by the fact that it is generally annular in shape.

9. A gasket according to claim 1, characterized by the fact that it is elliptical in shape.

10. A gasket according to claim 1, characterized by the fact that it is triangular in shape.

11. A gasket according to claim 1, characterized by the fact that it is rectangular in shape.

12. A gasket according to claim 1, characterized by the fact that opening (12) is placed toward the axis of symmetry of the gasket or opposite it.
